(19) United States
(12) Patent Application Publication
(10) Pub. No.: US 2011/0320087 A1
(43) Pub. Date: Dec. 29, 2011

(54) REMOTE CONTROL ADJUSTABLE THRESHING CAGE VANE SYSTEM AND METHOD

(76) Inventors: Herbert M. Farley, Elizabethtown, PA (US); Jonathan E. Ricketts, Ephrata, PA (US); John M. McKee, Seven Valleys, PA (US); Wayne T. Flickinger, Oxford, PA (US); Clinton T. Baltz, Lancaster, PA (US); Asish K. Panigrahi, Chatrapur (IN)

(21) Appl. No.: 12/825,894

(22) Filed: Jun. 29, 2010

(51) Int. Cl. G06F 7/00; A01F 12/28

(52) U.S. Cl. 701/29; 460/69; 701/50

(57) ABSTRACT

A system and method for remote control of an adjustable threshing cage vane, including while the threshing system is operating, for improving threshing performance and other operating parameters, utilizes an actuator in connection with the at least one vane and remotely controllable for adjustably varying the position thereof, e.g, pitch angle, within the cage for altering the path of the flow of the crop material therethrough. The remote control can be via an automatic controller to provide control responsive to one or more monitored operating parameters, such as grain loss, grain flow, ground speed, and/or throughput, as well as inputted commands.

### TECHNICAL FIELD

This invention relates generally to an adjustable threshing cage vane for the threshing system of an agricultural combine, and more particularly, to a system and method for remote control of an adjustable threshing cage vane, e.g., the pitch angle thereof, including while the threshing system is operating, for improving threshing performance and other operating parameters.

### BACKGROUND ART

It is known to utilize a plurality of vanes on the inner surface of a threshing rotor cage or casing to assist in guiding or directing the movement of the crop material through the threshing system of a combine. It is further known that such vanes can be manually moved and secured in several positions or orientations, namely, pitch angles, for a variety of reasons, including for different crop types or conditions. In a basic form the vanes are be bolted on the cage or casing at several different pitch angles relative to the axis rotation of a rotor of the system. In a more complex form, it is known to link multiple vanes for joint adjustment. Reference in this regard, DePauw et al., U.S. Pat. No. 4,244,380 issued Jan. 13, 1981 to International Harvester Co; and more recently, McKee et al., U.S. Pat. No. 7,473,170, issued Jan. 6, 2009 to CNH America LLC, the latter of which patents discloses visual indicia of vane position.

While manual setting of threshing cage vane position has utility, it suffers from shortcomings including inability to adjust during operation of the threshing system, particularly in real time, responsive to changing conditions, for instance, responsive to changing conditions such as varying crop conditions within a field, e.g., population/yield, moisture content; atmospheric conditions, e.g., humidity; ground speed; grain loss; and the like, and changes in other operating parameters or settings made in process, such as, but not limited to: threshing rotor speed; concave gap; power consumption, and the like. In this regard, threshing rotor speed and the concave gap (distance between a perforated concave region of the threshing cage or casing and the rotating rotor contained therein) are sometimes varied in process while harvesting for improving productivity, throughput and other conditions, but must be balanced with other factors such as possible grain cracking or other damage, and grain loss.

As a practical illustration of the possible impact of the above shortcomings, before and/or during a harvesting operation, a combine operator will set the rotor speed, that is, the rotational speed of the rotor or rotors within the threshing cage, and/or the concave gap. Settings for these parameters will be selected for various reasons, including, but not limited to, to accommodate or adjust for variations in crop moisture content and humidity, which can change over the course of a day, and between different crop varieties and regions of a field. Grain cracking and other damage can occur as a result of over aggressive threshing, which can result from high rotor speed and/or an undersized concave gap size. Higher than desired grain loss can result from settings of other systems of the combine, e.g., the grain cleaning system, and also from the threshing cage vane setting. In this latter regard, a steeper or more vertical vane pitch angle setting will typically result in the crop material flowing in a correspondingly steeper or tighter helical path through that region of the threshing cage, and thus greater dwell time in the threshing system for threshing and separating; while a less steep or more horizontal vane pitch angle will result in crop material flow at a less steep or looser helix and less dwell time, threshing and separating, which can result in increased grain loss.

Thus, what is sought is a manner of threshing cage vane position setting that provides the ability for real time adjustment while harvesting and optimization, while avoiding one or more of the shortcomings set forth above.

### SUMMARY OF THE INVENTION

What is disclosed in a is a system and method of remotely adjusting the positions of threshing cage vanes, which provides one or more of the advantages, and overcomes one or more of the shortcomings, set forth above.

According to a preferred aspect of the invention the system and method enable adjustably controlling the position of the vane or vanes, including while the threshing system is operating, for improving threshing performance and other operating parameters. Such parameters can include, but are not limited to, throughput, power consumption, and grain loss, and in particular, grain not threshed or separated from crop residue and thus which is carried through the body of the combine and lost by discharge from the combine with the residue. The vane position preferably comprises, but is not limited to, an angular position, particularly the pitch angle, relative to a reference such as a line or plane perpendicular to the axis of rotation of the rotor.

According to another preferred aspect of the invention, the threshing cage extends at least partially about the rotatable threshing rotor, the cage having an inner peripheral surface, and the rotor having an outer peripheral surface defining a circumferential gap therebetween for flow of crop material therethrough. The rotor includes threshing elements thereabout for passage through the gap during rotation of the rotor for threshing and separating grain from the crop material. At least one vane is disposed on the inner peripheral surface of the cage and projects into the gap in radially spaced relation to the threshing elements of the rotor for cooperating therewith upon rotation of the rotor to guide and direct the flow of the crop material along a path through the gap. And, the invention utilizes an actuator disposed in connection with the at least one vane and remotely controllable for adjustably varying the position thereof within the gap, e.g., pitch angle, for altering the path of the flow of the crop material through the gap.

According to another preferred aspect of the invention, a plurality of the vanes are linked together by a linkage arrangement for joint movement, and the actuator is connected to the linkage arrangement for jointly controlling the vanes. In this regard, one or more groups of vanes can be remotely controlled, jointly and simultaneously; or in groups of one or more vanes, as desired or required for a particular application.

According to another preferred aspect of the invention, an input device is provided at a location remote from the actuator, e.g., the operator cabin or platform of the combine, and is connected in operative control thereof, to enable adjustably varying the position of the at least one vane remotely as desired.

As another preferred aspect of the invention, a controller is provided in operative control of the actuator and operable responsive to inputted commands for controlling the actuator for positioning the at least one vane.

As another preferred aspect of the invention, one or more devices configured and operable for monitoring an operating parameter of the combine is provided, such as a grain loss monitor, ground speed monitor, power consumption monitor, or the like, and is connected to the controller and operable for outputting a signal representative of the monitored parameter to the controller, and the controller is configured and operable for automatically controlling the actuator for positioning the at least one vane responsive to the inputted signals, e.g., for limiting the grain loss, and/or power consumption, or adjusting for ground speed or throughput. As non-limiting examples, the actuator can comprise a linear actuator such as an electric or fluid driven actuator such as a fluid cylinder; a rotary actuator, e.g., bell crank, worm drive, etc., or a hand or foot operated device, such as a hand screw or lever operated device, that can be located in the body of the combine; on the exterior; or in the operator cabin or platform.

### BRIEF DESCRIPTION OF THE DRAWINGS

FIG. 1 is a side view of an agricultural combine showing aspects of a system for remotely adjusting threshing cage vanes thereof;

FIG. 2 is an enlarged end view of a threshing system of the combine of FIG. 1;

FIG. 3 is a fragmentary side view of the threshing system and aspects of the system of the invention;

FIG. 4 is a fragmentary sectional view of additional aspects of the system of the invention;

FIG. 5 is a high level flow diagram showing steps of a method of operation of the system of the invention;

FIG. 6 is a simplified side view of an alternative embodiment of aspects of the system of the invention;

FIG. 7 is a simplified side view of another alternative embodiment of aspects of the system of the invention;

FIG. 8 is a simplified side view of still another alternative embodiment of aspects of the system of the invention;

FIG. 9 is a simplified side view of another alternative embodiment of aspects of the system of the invention; and

FIG. 10 is a simplified side view of yet another alternative embodiment of aspects of the system of the invention.

### DETAILED DESCRIPTION OF THE INVENTION

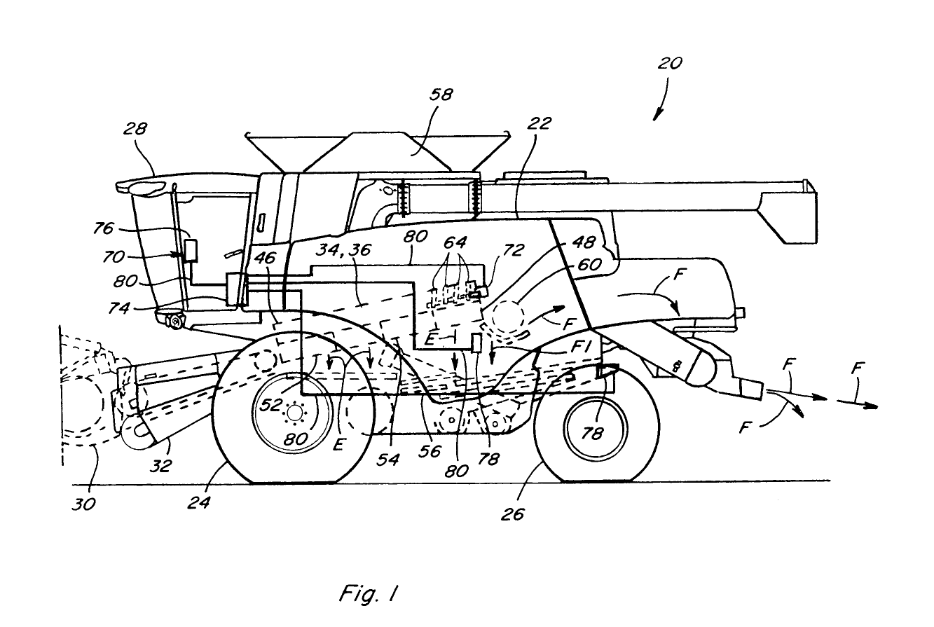

Referring now to the drawings wherein several preferred embodiments of the invention are shown, in FIG. 1 there is shown a representative self-propelled combine 20. Combine 20 includes a body 22 supported on front drive wheels 24 and rear steerable wheels 26. An operator cabin 28 sits atop a front or forward end of body 22, and from which an operator will control operation of the combine in the well known manner. Combine 20 is provided with a header 30 for cutting the standing crop and conveying the cut crop to a feeder 32, also in the well known manner. Feeder 32 forms the cut crop material into a generally flat mat and conveys the mat rearwardly into an inlet end of a threshing system 34, again, in the well known manner.

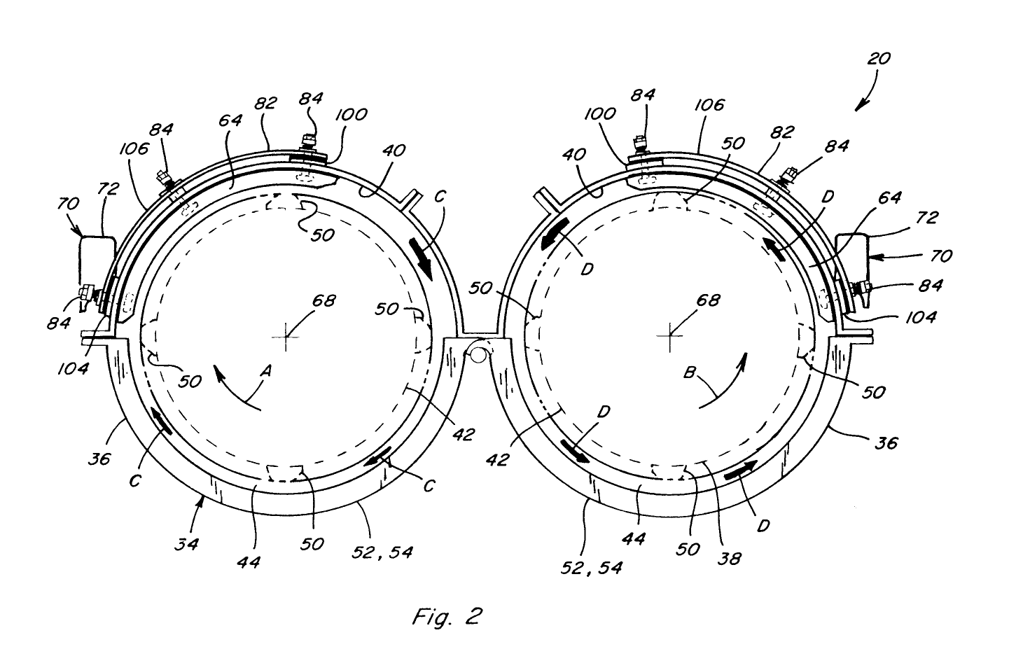

Referring also to FIG. 2, threshing system 34 here is depicted as a twin, axial rotor type system, including a pair of side by side, fore and aft extending, generally cylindrical threshing casing or cages 36, each extending about and containing a generally cylindrical rotor 38. Here, it should be noted that the present invention is not limited to twin rotor threshing systems, but has equal utility for a variety of configurations including one or more rotors, and also transversely or otherwise disposed rotors. Each cage 36 has a circumferential inner peripheral surface 40 facing a circumferential outer peripheral surface 42 of the associated rotor 38, in spaced relation thereto, forming and defining a circumferential or annular gap 44 therebetween extending about the rotor. Rotors 38 are rotated in a counter-rotating manner within cages 36, as depicted by arrows A and B, and are configured and operable in the well known manner for inducting the crop mat to flow through gaps 44 as denoted by arrows C and D, in a helical manner from a forward or inlet end 46, to a rear or discharge end 48 (FIG. 1) of each cage 36.

A plurality of threshing elements 50 are disposed at various locations about outer peripheral surfaces 42 of rotors 38, and cooperate, respectively, with surface features of cage 36, namely, perforated concave sections 52 and grate sections 54, along a bottom region thereof, to thresh the crop material such that most of the grain will be separated from material other than grain (MOG). As a result, the grain and smaller MOG, will be impelled downwardly through the concave and grate sections 52 and 54, while the larger MOG and any remaining grain therein will be expelled from discharge end 48 of the threshing system. Briefly, concave sections 52 consist of several removable arcuate panels extending along about the forward one-half or so of the lower region of cage 36. Likewise, the grate sections 54 consist of several removable arcuate panels extending the remaining half or so of the length of cage 36. The concave sections 52 and grate sections 54 thus generally define respective threshing and separating zones.

The grain and smaller MOG which passes through concave and grate sections 52 and 54 will fall and/or be conveyed to a cleaning system 56 disposed below threshing system 34, as denoted generally by arrows E in FIG. 1. Cleaning system 56 will then separate the grain from the smaller MOG, and the clean grain will be conveyed to a clean grain tank 58 atop combine 20, and the smaller MOG will be discharged from the combine or reprocessed. Meanwhile, the larger MOG and residual grain discharged from threshing system 34, as denoted by arrows F, will be processed and discharged from the combine by residue processing apparatus, here including a beater apparatus 60 disposed adjacent to discharge end 48 of system 34 and operable for propelling the MOG rearwardly through body 22, and a chopper/spreader 62 configured and operable for optionally chopping and spreading the MOG over a field (arrows F), although a wide variety of other residue processing apparatus configurations could be used.

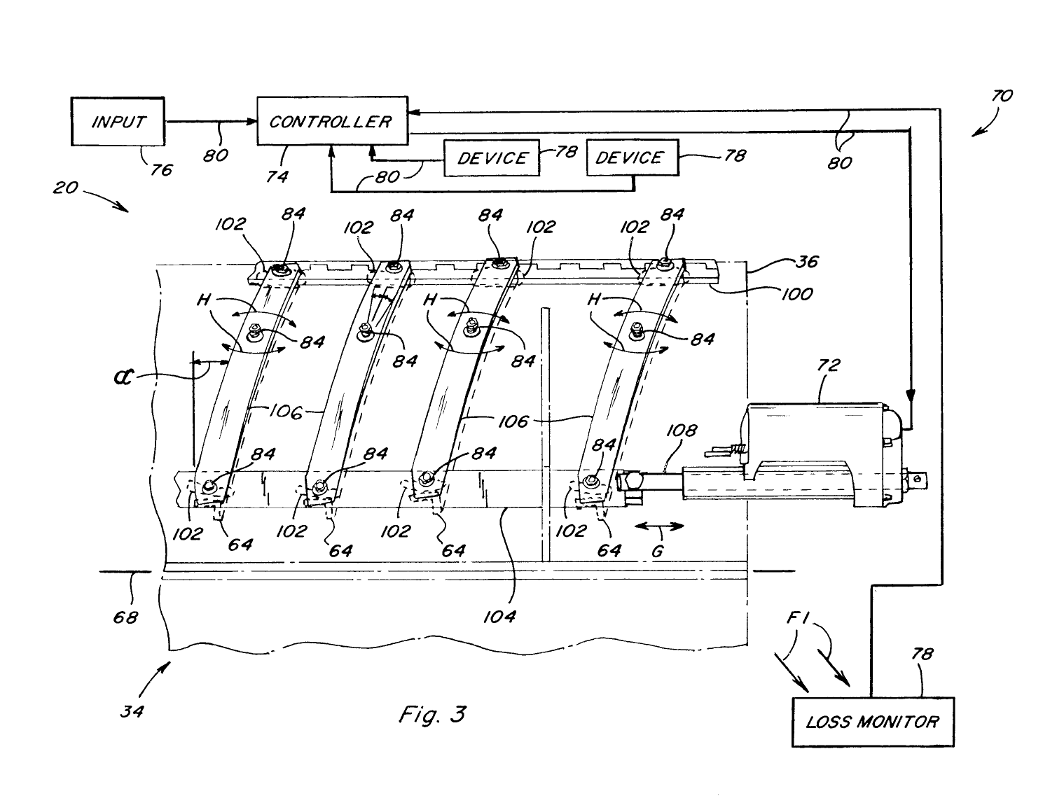

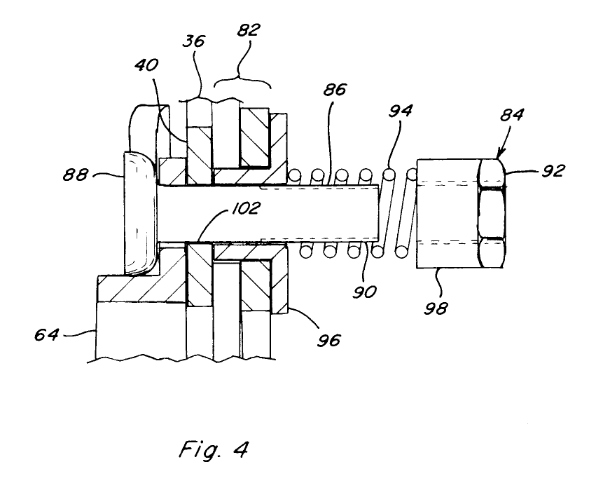

Referring also to FIGS. 3 and 4, threshing system 34 includes a plurality of vanes 64 disposed on an upper region of inner peripheral surface 40 of cage 36 adjacent to discharge end 48. Each vane 64 generally comprises an elongate, member, of L-shaped or other suitable cross section, and curved or resiliently curvable into at least substantially conforming relation to the curvature of inner peripheral surface 44, including when positioned at various angles or orientations, while projecting into gap 44. Vanes 64 are each positioned and oriented at a nominal pitch angle α (FIG. 3) relative to a line or plane 66 perpendicular to an axis of rotation 68 of the associated rotor 38. Pitch angle α can be the same for all of the vanes, or can vary or be varied one relative to the other, as desired or required for a particular application. An example of a representative pitch angle α for a common threshing system is 21½+/−6 degrees, although a wide variety of angles can be used as best suited to a particular threshing system. Vanes 64 can also be evenly spaced apart axially, or at different spacings as desired or required. Thus, the arrangements shown here are for illustration only and are not intended to be limiting, including in regard to the shape and configuration of the individual vanes.

Vanes 64 function to guide or direct the flow of crop material, denoted by arrows C and D in FIG. 2, and arrows D in FIG. 3, rearwardly through the respective gaps 44, as propelled by the rotation of the respective rotors 38 and the associated threshing elements 50 thereon. Pitch angle α at which vanes 64 are disposed is typically considered to be a critical parameter with respect to separation and power requirements for operating the threshing system, as explained more fully in U.S. Pat. No. 7,473,170 referenced above, the disclosure of which is incorporated herein by reference in its entirety. Generally, the pitch angle α controls the axial speed at which the crop material travels through the rear region of gap 44 and thus the dwell time of the crop in the separating area, i.e., adjacent grate sections 54. Thus, as a general rule, a smaller pitch angle α will result in a tighter helical path and lower axial speed or rate of movement of the crop material through gap 44, which will typically increase the separation opportunity for the grain to pass through grate sections 54. Conversely, a larger pitch angle α will result in a looser helical path and higher axial speed or rate of movement of the crop material through gap 44, which will typically decrease the possibility of the grain to pass through grate sections 54. A smaller pitch angle will also typically require more power, while a larger angle will consume less.

The concept of varying pitch angle α has been well developed, as evidenced by the above referenced patents, as well as others. However, this has been in the context of providing means of manual adjustment for smaller changes, and even replacement of sets of vanes with set having different fixed pitch angles α, e.g., 20, 30, or 45 degree, as variously advantageous for different crops and applications. It is also well known to provide linkages connecting the vanes to allow joint or simultaneous adjustment. What has not been explored, at least not to the sophistication of the present invention, is the varying of vane position, e.g., pitch angle α, in process, that is, while the threshing system is operating, and doing so in real time response to multiple parameters, e.g. real time grain loss, power consumption, throughput, etc. An advantage of this capability would be the ability to make vane adjustments responsive to an observed operating parameter or parameters, namely, grain loss, or grain flow and grain flow distribution from the threshing system, in real time, to achieve and maintain optimum performance, and respond to changing conditions.

To achieve the above advantages, the present invention is directed to a system 70 and method to enable adjustably controlling the position of the vane or vanes 64, including while threshing system 34 is operating, for improving threshing performance and other operating parameters. Such parameters can include, but are not limited to, grain loss, and in particular, grain not threshed or separated from crop residue and thus which is discharged from the threshing system and the combine with the larger MOG, and that which may end up as tailings that will be processed by the cleaning system and possibly reprocessed by a tailings return system of the combines or discharged, typically depending on settings of the cleaning system and a tailings return system if used. The affected vane position preferably comprises pitch angle α, although the invention is not limited to that positional parameter.

As shown variously in FIGS. 1, 2 and 3, system 70 includes the vane or vanes 64 to be adjusted; an actuator or actuators 72 in connection therewith configured and operable for effecting and holding the adjustments; a controller 74 in operative control of actuator or actuators 72; an input device 76 operable for inputting commands to controller 74; and a device 78 or devices 78 configured and operable for generating or monitoring information representative of an operating parameter or parameters to be sensed or monitored, all connected together by suitable conductive paths 80, which can be, for instance, but are not limited to, wires of a wiring harness, or a controller area network or other suitable wired or wireless communications network.

Referring also to FIG. 4, as a preferred aspect of the invention, a plurality of vanes 64 are linked together by a linkage arrangement for joint movement, aspects of one preferred linkage arrangement 82 being shown in FIGS. 3 and 4. Each vane 64 is pivotally mounted on cage 36 and resiliently biased in conforming relation to inner peripheral surface 40 thereof, in cooperation with associated aspects of linkage 82 which are biased against the outer surface thereof, by a plurality of biased fastener arrangements 84, each here including a threaded bolt 86 which passes through an aperture or slot of cage 36 and having a flared end 88 and an opposite threaded end 90 threadedly engaged by a nut 92. Bolt 86 captures and compresses a biasing element 94, which here is a coil spring, between two spring retainers 96 and 98 for providing the resilient biasing, including against the vane 64 on the inside of cage 36, and against the related aspects of the associated linkage arrangement 82, to allow adjusting movements as required.

Each linkage arrangement 82 defines a parallelogram including a first tie bar 100 which extends axially along and is pivotally secured to the exterior of cage 36 by a series of fastener arrangements 84 which extend through apertures through cage 36 which here comprise slots 102. Similarly, a second tie bar 104 is mounted on the exterior of the cage 36 generally parallel to and spaced below first tie bar 100, also by a series of fastener arrangements 84 through additional slots 102. Tie bar 100 is pivotally secured to the upper ends of respective vanes 64, and to the upper ends of accompanying levers 106 extending parallel and in overlaying relation thereto but on the exterior of cage 36, by the fastener arrangements, and tie bar 104 is connected to the bottom ends of the vanes and levers in the same manner. As a result, opposite longitudinal movements of tie bars 100 and 104 will cause corresponding pivotal movements of levers 106, and also vanes 64, all of which are tied together by fastener arrangements 84.

Each actuator 72 of system 70 is mounted externally to respective cage 36, or to suitable adjacent fixed structure. Each actuator 72 here includes an actuator rod 108 connected to the rear lower end of linkage arrangement 82 by a clevis 110. Actuators 72 here are electric linear actuators, constructed and operable in the well known manner, and operable for extending and retracting rods 108 thereof, as denoted by arrow G, as commanded by controller 74, for effecting opposite longitudinal movements of tie bars 100 and 104 of each linkage arrangement 82, which will cause pivotal movement of levers 106 and vanes 64, as denoted by arrows H, and thus vary pitch angles α accordingly.

Controller 74 of system 70 is preferably a micro-processor based device controllably operable in a manual or input control mode for controlling actuators 72 responsive to input commands received from input device 76, which can be, for instance, a switch, touch screen or other convenient device located in operator cabin 28 or at another desired location, and operable by an operator for inputting desired commands or settings to system 70. Controller is also preferably configured and programmed to have a selectable automatic mode wherein it will automatically respond to inputs received from device or devices 78, which here include a grain loss monitor of conventional construction and operation, configured and operable for monitoring grain loss or flow from threshing system 34, as denoted by arrow F1 in FIG. 3.

Grain loss or flow from system 34 can be monitored in various ways, including by positioning a monitor or monitors 78 for monitoring grain flow through grate sections 54, or through perforations of an underlying pan of beater apparatus 60, as denoted by arrow F1 in FIGS. 1 and 3. In both instances, the grain flow actually measured will still be directed to cleaning system 56, but if it is observed to increase or decrease as a result of varying vane position, this will be indicative that there is recoverable grain lost with flow F from the combine and this data can be used for developing quantitative data and process optimization. Similarly, a device 78 employed for sensing flow through a tailings recovery system of the combine and any changes in tailings flow associated with varying vane position can be used for optimizing the process. Still further, data from a grain loss monitor 78 (FIG. 1) associated with losses from cleaning system 56 that changes with vane settings can be utilized for optimization of those and other settings.

Other embodiments of devices 78 that are contemplated for use with system 70 include a ground speed sensor, and a force sensor in connection with cage 36 which can provide a metric of crop throughput, and a power consumption or engine load sensor which can measure threshing system power consumption, can also be used. Any or all of the data from devices 78 as well as input commands from input device 76, can be used, e.g., in a decision map or matrix, for determining a most advantageous or optimized vane setting for a particular application, on a real time, continuing, or intermittent or periodic basis. For example, it may be desired to manage power consumption as a function of grain loss, or visa versa, as the parameter to be optimized for a particular application.

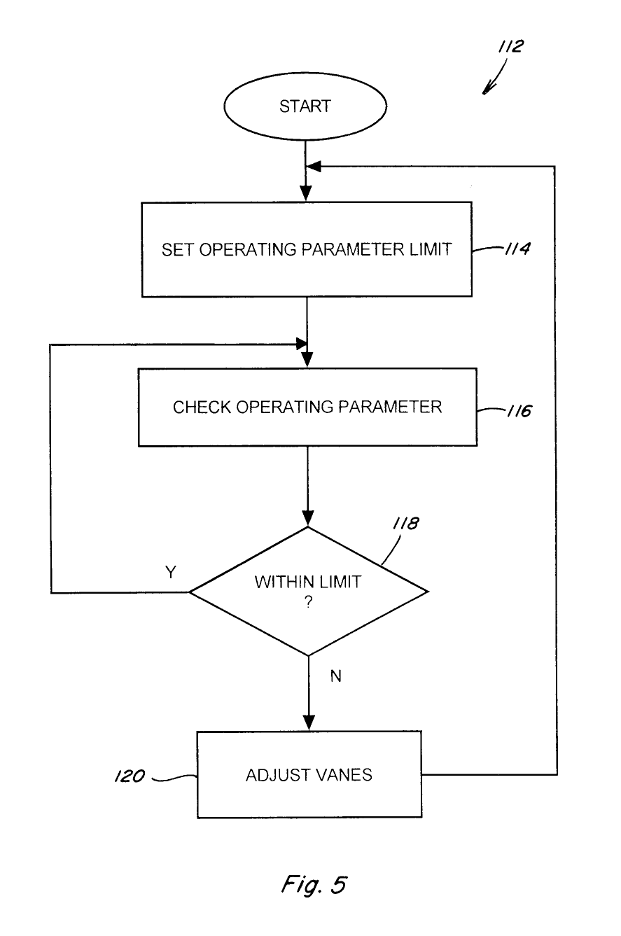

Referring also to FIG. 5, a high level flow diagram 112 showing steps of a preferred method of system 70 for automatically adjusting or varying pitch angles α of vanes 64 responsive to signals representative of a desired or selected operating parameter or parameters limit, in real time, including while combine 20 is operating in a harvesting mode, is shown. Here, as noted above, the selected parameter or parameters can comprise any or all of those just discussed, as well as others, e.g., concave gap, rotor speed, etc., as inputted and/or detected by device or devices 78, without limitation. As will be a typical first step, an operator or system of combine 20 will set a value for the selected parameter or parameters. Thereafter, controller 74 will automatically monitor signals received from device or devices 78, either periodically or continuously, as denoted by block 116. The values represented by these signals will then be compared by the controller to the limit, as denoted by decision block 118. If the operating parameter or parameters, e.g., grain loss is within the limit, the controller will loop through blocks 116 and 118. If the operating parameter is outside of the limit, then the controller will adjust the vane position (pitch angle α) in the above described manner, as denoted by block 120, then loop back to block 114. In regard to adjustments, for the above example of grain loss, if the grain loss or flow exceeds a maximum limit, the pitch angle α can be automatically decreased, to increase the dwell time that the crop material will remain within the threshing system, to increase the opportunity for grain recovery. Conversely, if grain loss is below a lower limit, angle α can be increased, for instance, to reduce power consumption and save energy. As another example, if grain loss is within the limit, another parameter, e.g., rotor speed or ground speed, may be increased to increase productivity or throughput, while still maintaining grain loss within the limit. Additionally, if system 70 is unable to return the parameter to the limit, a warning or signal can be outputted, to enable the operator (or another system of combine 20) to take other action, as desired or required, e.g., decrease rotor and/or ground speed. Settings for the parameter can also be automatically saved for later use or analysis. As a result, vane pitch angle can be continuously controlled and adjusted, in process, while harvesting, as desired or required.

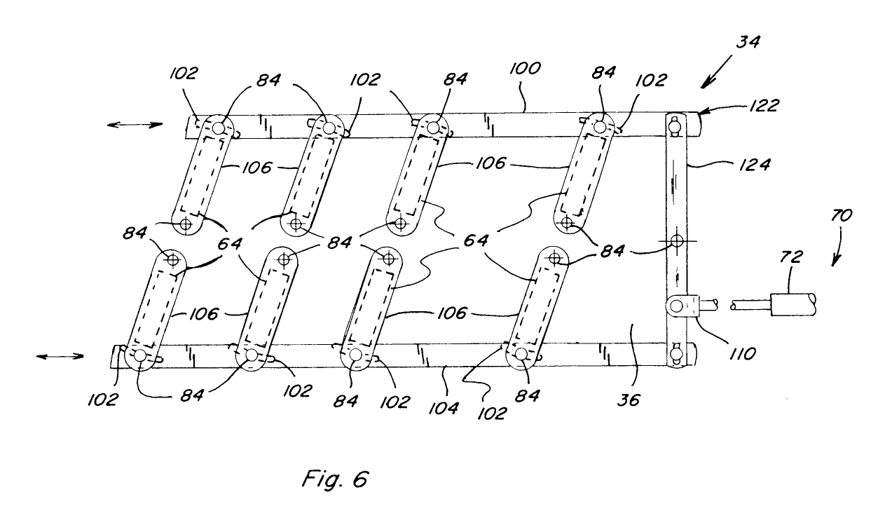

Referring also to FIGS. 6, 7, 8, 9 and 10, several alternative linkage arrangements and actuator arrangements which can be used with system 70 of the present invention, and threshing system such as, but not limited to, system 34, are shown. For example, in FIG. 6, a split vane linkage arrangement 122 is shown, which is a parallelogram arrangement configured and operable for changing vane pitch angle similarly to arrangement 82, but utilizing shorter split vanes 64 pivoted at one end instead of the middle. Here, each vane 64 is supported for pivotal movement in connection with a shorter lever 106, by a pair of fastener arrangements 84, one of which extends through a slot 102 through cage 36. That end is also pivotally connected to a tie bar 100 or 104, which pivotally connect at one end to a yoke 124, pivotally connected via a clevis 110 to an actuator 72 of system 70.

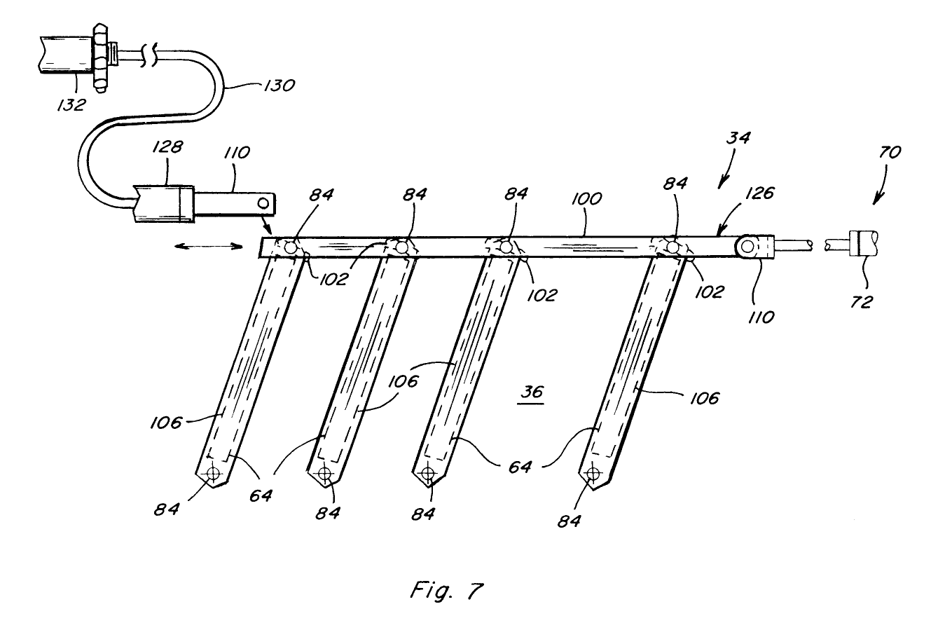

In FIG. 7, a single pivot linkage arrangement 126 is shown. Linkage arrangement 126 is also configured and operable for changing vane pitch angle, but utilizes longer vanes 64 pivotable about one end. Here, each vane 64 is supported for pivotal movement in connection with a longer lever 106, by a pair of fastener arrangements 84 through cage 36, one of which extends through a slot 102. That end is also pivotally connected by the fastener arrangement 84 to a tie bar 100. Tie bar 100 has one end which pivotally connects to actuator 72 via a clevis 110. Again, actuator 72 is operable in essentially the above described manner for adjusting the pitch angle of the vanes. Here also, an alternative actuator 128 is shown which includes a cable 130, one end of which pivotally connects to one end of bar 100 by a clevis 110 or other suitable connector, and an opposite end that extends to a threaded adjuster 132 which can be remotely located, e.g, in operator cabin 28, and which is operable for adjusting the pitch angles. This actuator can be used with any of the other linkage arrangements of the invention, as desired or required for a particular application.

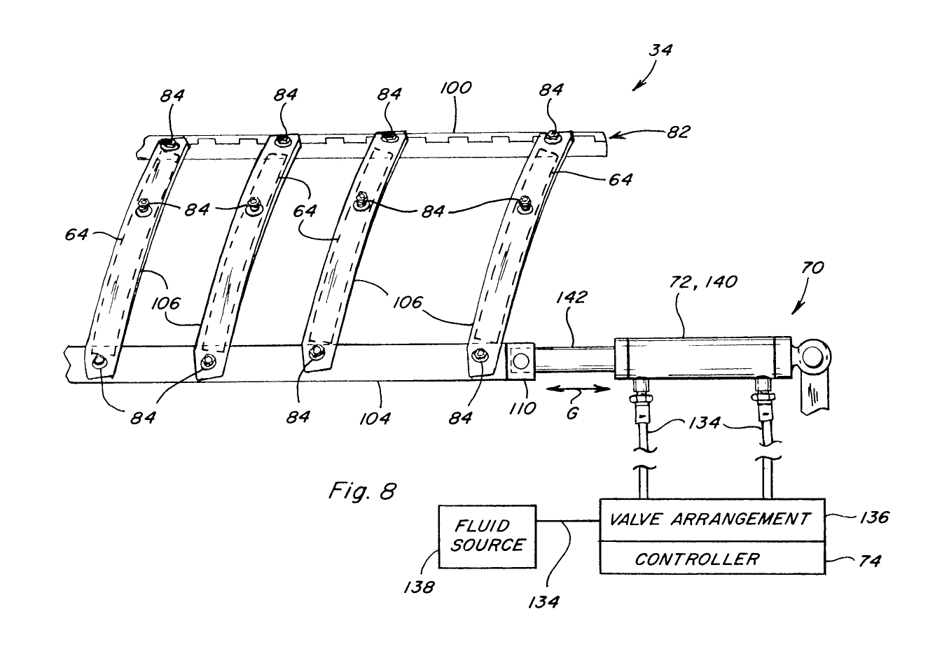

FIG. 8 shows linkage arrangement 82 as above, with levers 106 supporting vanes 64 in the above described manner, connected together through cage 36 of threshing system 34 via fastener arrangements 84, the levers being connected together and to an actuator 72 of system 70, via tie bars 100 and 104, and clevis 110. Here though, actuator 72 is a fluid cylinder 140, connected via fluid lines 134 to a valve arrangement 136 connected via lines 134 to a pressurized fluid source 138 on combine 20 and under control of controller 74. Controller 74 will be connected to the other aspects of system 70, e.g., input device 76, device or devices 78, in the above described manner, and is automatically operable for controlling valve arrangement 136 for controlling cylinder 140 in a manner analogous to that described above for effecting movements G of a rod 142 thereof, for varying the vane pitch angles.

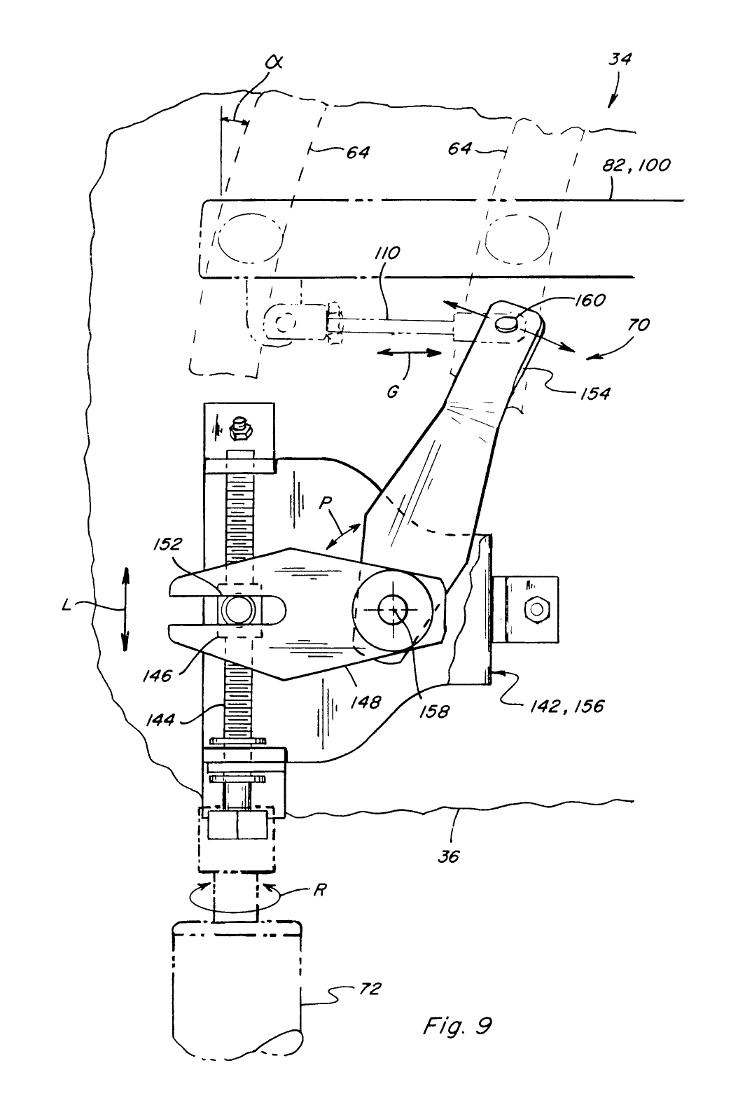

FIG. 9 shows linkage arrangement 82 as above, with vanes 64 supported by levers in the above described manner, connected together through cage 36 of threshing system 34, the levers being connected together and to an actuator 72 of system 70, via a tie bar 100, a clevis 110, and a bell crank mechanism 142. Here, actuator 72 is an electrically powered rotary actuator having a threaded output shaft 144, precisely rotatable, as denoted by arrow R, under control of a suitable controller, e.g., controller 74 discussed above, connected thereto via a suitable conductive path, e.g., wires of a wiring harness, a wireless communication network, or the like. Controller 74 will be connected to the other aspects of system 70, e.g., input device 76, device or devices 78, in the above described manner, and is automatically operable for controlling actuator 72 to rotate shaft 144.

Bell crank mechanism 142 includes a nut 146 disposed about and threadedly engaged with shaft 144, and restrained from rotation but not longitudinal movement therealong, by connection to an input arm 148 of an L shaped armature 150 of mechanism 142 via a sliding pin joint 152. Armature 150 has an opposite output arm 154 connected at a fixed angle to input arm 148, and is pivotable as a unit relative to a frame 156 of mechanism 142 about a pivot joint 158 connecting it to frame 156. Frame 156 is mounted to cage 36 or other suitable fixed structure in a suitable manner, such as with threaded fasteners shown, or the like. Output arm 154, in turn, is connected by a pivot joint 160, to clevis 110. As a result, rotation of output shaft 144 by actuator 72 as denoted by arrow R, will cause longitudinal movement of nut 146, as denoted by arrow L, which will cause pivotal movement of armature 148, as denoted by arrow P, to cause longitudinal movement G of clevis 110 and thus movement of linkage arrangement 82 for varying the pitch angle α, as desired. Here, as a non-limiting example for the representative threshing system discussed above, an angular range of movement of 21½+/−6 degrees can be achieved.

An advantage of the arrangement of FIG. 9 lies in its resolution capability, which allows multiple rotations of output shaft 144 to achieve only small changes in pitch angle α. This arrangement is also advantageous as it is robust, and enables exerting a relatively strong force against linkage arrangement 82 and the vanes for changing the angular position thereof in opposition to grain flow forces exerted thereagainst, and also obstructions such as corn cobs and the like that may be in the path of elements of the linkage or vanes, and for holding the vanes in position against such forces.

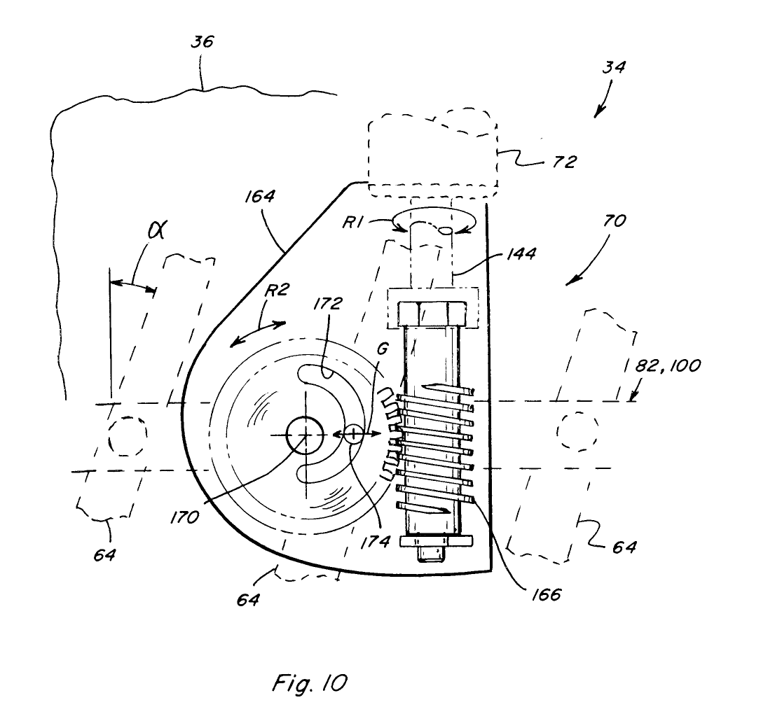

FIG. 10 shows linkage arrangement 82 as above, with vanes 64 supported by levers in the above described manner, connected together through cage 36 of threshing system 34, the levers being connected together and to an actuator 72 of system 70, via a tie bar 100, adjustably movable as denoted by arrow G, by a worm drive cam mechanism 162. Worm drive cam mechanism 162 includes a frame 164 suitably mounted to cage 36 or another suitable fixed structure. Actuator 72 again is an electrically powered rotary actuator having a threaded output shaft 144, precisely rotatable, as denoted by arrow R1, under control of a suitable controller, e.g., controller 74 discussed above, connected thereto via a suitable conductive path, e.g., wires of a wiring harness, a wireless communication network, or the like. Controller 74 again will be connected to the other aspects of system 70, e.g., input device 76, device or devices 78, in the above described manner, and is automatically operable for controlling actuator 72 to rotate shaft 144. Here shaft 144 includes a worm gear 166 enmeshed with a cam gear 168 supported on frame for rotation about an axis 170 as denoted by arrow R2. Cam gear 168 has an arcuate cam slot 172 disposed in offset relation to axis 170, which receives a pin 174 fixedly connected to tie bar 100. Cam slot 172 is configured and positioned such that rotation R2 will cause movement of tie bar 100 and vanes 64 of linkage arrangement 82, to change pitch angle α as desired. Again, as a non-limiting example for the representative threshing system discussed above, an angular range of movement of 21½+/−6 degrees can be achieved. An advantage of this arrangement again lies in its resolution capability, which allows multiple rotations of output shaft 144 to achieve only small changes in pitch angle α. This arrangement is also advantageous as cam gear 168 and its mounting structure will absorb most of the grain flow forces.

Here, although the system and method of the invention are described in reference to a combine 20 including a twin rotor configuration, the teachings of the invention are not so limited, and can be applied to, and have utility for a wide variety of combine and threshing system configurations, including conventional rotors, transverse rotors, hybrid systems, and the like, and is thus not limited to any one configuration.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. A system for controlling a position of a vane within a threshing cage of an agricultural combine, comprising:
a threshing cage extending at least partially about a rotatable threshing rotor, the cage having an inner peripheral surface and the rotor having an outer peripheral surface defining a gap therebetween for flow of crop material therethrough, the rotor including threshing elements thereabout for passage through the gap during rotation of the rotor for threshing and separating grain from the crop material;
at least one vane disposed on the inner peripheral surface of the cage and projecting into the gap in radially spaced relation to the threshing elements of the rotor for cooperating therewith upon rotation of the rotor to guide the flow of the crop material along a path through the gap; and
an actuator disposed in connection with the at least one vane and remotely controllable from a location spaced from the at least one vane for adjustably varying the position thereof within the gap for altering the path of the flow of the crop material through the gap.

2. The system of claim 1, including a plurality of the vanes linked together by a linkage arrangement for joint movement, and wherein the actuator is connected to the linkage arrangement.

3. The system of claim 1, wherein the position of the at least one vane comprises a pitch angle of the vane.

4. The system of claim 1, wherein the at least one vane is supported on the inner peripheral surface by a mounting assembly extending through a wall of the cage to an exterior thereof and connecting to the actuator.

5. The system of claim 1, further comprising an input device at a location remote from the actuator and connected in operative control of the actuator for adjustably varying the position of the at least one vane.

6. The system of claim 5, further comprising a controller connected to the input device for receiving commands therefrom, the controller being connected in operative control of the actuator and operable responsive to inputted commands for controlling the actuator for positioning the at least one vane.

7. The system of claim 6, further comprising at least one device configured and operable for monitoring an operating parameter of the combine, the device being connected to the controller and operable for outputting a signal representative of the monitored parameter to the controller, and the controller being configured and operable for automatically controlling the actuator for positioning the at least one vane responsive to the inputted signal.

8. The system of claim 7, wherein the device comprises a loss monitor configured and operable for monitoring grain loss from a region of the combine, and the controller is configured and operable for automatically controlling the actuator for adjustably positioning the vane for reducing the grain loss.

9. The system of claim 1, wherein the actuator comprises a linear actuator.

10. The system of claim 1, wherein the actuator comprises a rotary actuator.

11. A remote control system for varying a position of a threshing cage vane in an agricultural combine, comprising:
a threshing cage extending at least partially about a rotatable threshing rotor, the cage having an inner peripheral surface and the rotor having an outer peripheral surface defining a gap therebetween for flow of crop material therethrough, the rotor including threshing elements thereabout for passage through the gap during rotation of the rotor for threshing and separating grain from the crop material;
at least one vane disposed on the inner peripheral surface of the cage and projecting into the gap in radially spaced relation to the threshing elements of the rotor for cooperating therewith when the rotor is rotated for guiding the flow of the crop material along a path through the gap;
an actuator disposed in connection with the at least one vane and controllable from a remote location for adjustably varying the position thereof within the gap for altering the path of the flow of the crop material through the gap; and
a controller connected in operative control of the actuator and automatically operable for operating the actuator for adjustably varying the position of the at least one vane responsive to an input to the controller.

12. The system of claim 11, further comprising an input device connected to the controller and operable for outputting the input thereto.

13. The system of claim 11, further comprising at least one device operable for sensing an operating parameter of the combine and outputting the input to the controller as representative of the parameter.

14. The system of claim 13, wherein the device comprises a monitor operable for sensing grain flow from a region of the cage.

15. The system of claim 11, wherein the actuator comprises a linear actuator.

16. The system of claim 11, wherein the actuator comprises a rotary actuator.

17. The system of claim 11, wherein the at least one vane comprises a plurality of the vanes connected together and to the actuator by a linkage arrangement.

18. A method for automatically controlling position of a vane within a threshing cage of an agricultural combine, comprising steps of:
automatically monitoring at least one operating parameter of the combine; and
adjusting the position of the vane while the combine is harvesting, responsive to the at least one monitored parameter.

19. The method of claim 18, wherein the monitored operating parameter comprises grain loss from the combine.

20. The method of claim 18, comprising a further step of initially adjusting the position of the vane responsive to an inputted command.

21. The method of claim 18, comprising a step of providing an actuator connected to the vane and controllably operable for moving the vane.

22. The method of claim 21, comprising a step of providing a controller in operative control of the actuator and in connection with a device operable for monitoring the operating parameter and outputting a signal representative thereof to the controller.

23. The method of claim 22, wherein the device comprises a loss monitor.

24. The method of claim 22, wherein the position of the vane comprises a pitch angle thereof.

25. The method of claim 18, wherein the monitored operating parameter comprises a ground speed of the combine.

26. The method of claim 18, wherein the monitored operating parameter comprises throughput of crop material through the combine.
